(19) United States
(12) Patent Application Publication
(10) Pub. No.: US 2004/0150741 A1
(43) Pub. Date: Aug. 5, 2004

(54) Image-pickup apparatus

(76) Inventors: Tsuyoshi Togawa, Tokyo (JP); Toru Hidaka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/705,239

(22) Filed: Nov. 12, 2003

(30) Foreign Application Priority Data
Nov. 15, 2002 (JP) 2002-332446
Nov. 19, 2002 (JP) 2002-335515

(51) Int. Cl. H04N 5/232

(52) U.S. Cl. 348/345

(57) ABSTRACT

An image-pickup apparatus includes a shape-variable mirror having a deformable reflection plane. When an image-pickup unit is picking up images, a control unit controls a drive unit so as to continuously feed a drive signal in order to maintain a displacement state of the shape-variable mirror. Therefore, during photographing, by maintaining the displacement state of the shape-variable mirror, required images can be obtained while at non-required time, electric power consumption can be reduced by stopping the drive of the shape-variable mirror. Also, prior to picking up images, in order to avoid the extreme defocus of the focal position of an optical system, exposure is controlled by applying a predetermined drive signal to-the shape-variable mirror, so that an object can be auto-focused in an appropriate exposure state, enabling a focal point to be correctly detected not depending on the brightness of the object.

This application claims benefit of Japanese Application Nos. 2002-332446 filed in Japan on Nov. 15, 2002 and 2002-335515 filed in Japan on Nov. 19, 2002, the contents of which are incorporated by this reference.

### BACKGROUND OF THE INVENTION

1. Field of the Invention

The present invention relates to an image-pickup apparatus having an optical system including an active optical element, and in particular relates to an image-pickup apparatus using a shape-variable mirror.

2. Description of the Related Art

As an image-pickup apparatus in that optical object images are focused on a CCD (Charge Coupled Device) and a silver salt film by an optical system, various apparatuses such as a digital camera, a video camera, and a silver film camera, have been proposed and manufactured.

Among these image-pickup apparatuses, there are a number of apparatuses having an automatic focus-control function for automatically controlling a focus point.

As for the automatic focus-control function, an active or passive trigonometrical-distance measurement sensor has been used in various cameras. Whereas in a camera using an image-pickup element such as a digital camera, a contrast detection system in that an optimum focusing position is obtained based on the contrast of a photographing signal has been mostly adopted. For example, a position of a taking lens has been controlled by incorporating a mountain climbing system.

In more detail, the contrast detection system is a system in that a high-frequency component in an object image signal is extracted as an evaluation value corresponding to a taking-lens position so as to control the taking lens at a position with a maximum evaluation value.

On the other hand, an active optical element has been proposed having a functional region formed so as to emit light by converting optical characteristics of incident light in accordance with an applied drive signal. As such an active optical element, a shape-variable mirror capable of changing optical characteristics by deforming the shape of a reflection plane thereof is exemplified as an example.

The shape-variable mirror can electrically deform a reflection plane with a free-form curved surface so as to be able to obtain desired optical characteristics without mechanically shifting a lens. By using the shape-variable mirror in an optical system of an image-pickup apparatus such as a digital camera, the reduction in size and weight can be achieved. An optical apparatus having such a shape-variable mirror is disclosed in Japanese Unexamined Patent Application Publication No. 2002-122784 (P1 to P8 and P46, and FIG. 1), for example.

Also, a digital camera using such a shape-variable mirror is disclosed in Japanese Unexamined Patent Application Publication No. 2002-221751 (P13 to P14, FIGS. 36 and 45), for example.

According to the above-mentioned publications, by using the shape-variable mirror, zooming and auto-focusing can be operated without displacement of lenses, so that a motor used for moving zooming and auto-focusing lenses can be eliminated so as to achieve life elongation of a camera battery due to the reduction in power and reduction in size and weight of the camera.

Also, a technique regarding auto-focusing of a digital camera using a shape-variable mirror is also described in Japanese Unexamined Patent Application Publication No. 2002-229100, for example. In this proposal, after measuring a distance, measuring-light operation is to be executed.

### SUMMARY OF THE INVENTION

An image-pickup apparatus according to the present invention comprises a shape-variable mirror having a deformable reflection plane and an electrode for controlling the shape of the reflection plane; a drive unit for feeding a signal for driving the reflection plane to the electrode; a taking-lens system for defining a focal length in accordance with the deformation amount of the reflection plane of the shape-variable mirror; an image-pickup unit for picking up images focused via the taking-lens system and the shape-variable mirror; and a control unit for controlling the drive unit so as to continuously feed the drive signal in order to maintain the deformation state of the shape-variable mirror when the image-pickup unit is picking up images for use in one or part of a process of a subsequent stage.

Also, an image-pickup apparatus according to the present invention comprises an optical system comprising an active optical element having a functional region that converts optical characteristics of incident light in accordance with an applied drive signal so as to emit it; an image-pickup element that photo-electrically converts object images focused via the optical system; a signal processing unit for processing an image-pickup signal of the object images produced from the image-pickup element in a predetermined manner; an active optical-element drive unit for producing a drive signal to be applied to the active optical element; and a control unit for controlling the active optical-element drive unit.

The above and other objects, features and advantages of the invention will become more clearly understood from the following description referring to the accompanying drawings.

### BRIEF DESCRIPTION OF THE DRAWINGS

FIG. 1 is a block diagram of an image-pickup apparatus according to a first embodiment of the present invention;

FIG. 2 is an exploded perspective view showing a principle structure of a shape-variable mirror according to the first embodiment of the present invention;

FIG. 3 is an explanatory view for illustrating the principle structure by showing a cross-sectional shape of the shape-variable mirror according to the first embodiment of the present invention;

FIG. 4 is an operational flowchart according to the first embodiment;

FIGS. 5A and 5B are timing charts for illustrating operation according to a second embodiment of the present invention;

FIG. 6 is a block diagram of an image-pickup apparatus according to a third embodiment of the present invention;

FIGS. 7A to 7C are timing charts for illustrating operation according to the third embodiment;

FIGS. 8A and 8B are timing charts for illustrating operation without a mechanical shutter according to a fourth embodiment of the present invention;

FIGS. 9A to 9C are timing charts for illustrating operation with the mechanical shutter according to the fourth embodiment;

FIG. 10 is an operational flowchart according to a fifth embodiment of the present invention;

FIG. 11 is a block diagram of a structure of a digital camera according to a sixth embodiment of the present invention;

FIG. 12 is a block diagram of a structural example of a mirror control unit according to the sixth embodiment of the present invention;

FIG. 13 is a table showing a data example stored in an LUT according to the sixth embodiment of the present invention; and

FIG. 14 is a table showing conditions that the input into the LUT changes with a focal length according to the sixth embodiment of the present invention.

### DETAILED DESCRIPTION OF PREFERRED EMBODIMENTS

Embodiments of the present invention will be described with reference to the drawings.

### First Embodiment

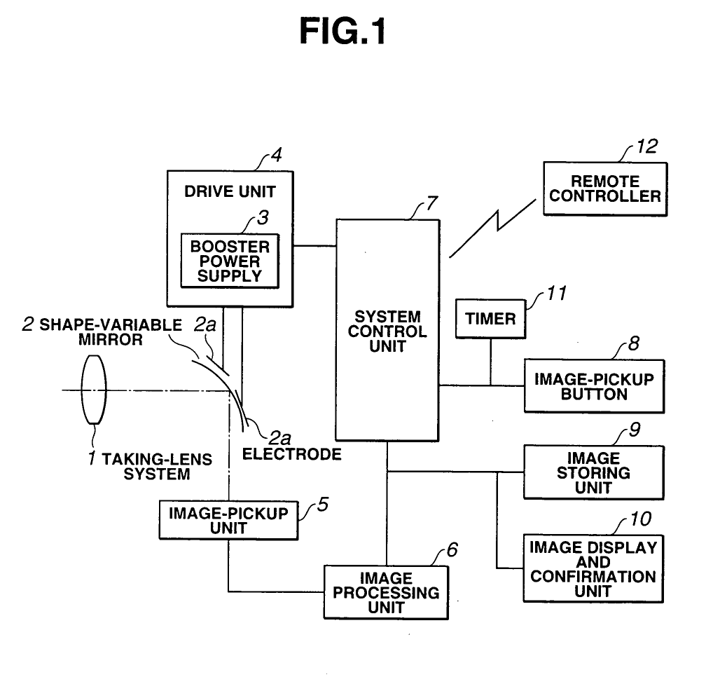

FIG. 1 is a block diagram showing an image-pickup apparatus according to a first embodiment of the present invention. As the image-pickup apparatus, a structural example of a digital camera is shown.

The digital camera is constructed to include a taking-lens system 1, a shape-variable mirror 2 having a deformable reflection plane and an electrode for controlling the shape of the reflection plane, a drive unit 4 having a booster power supply 3 for feeding a drive signal for driving the shape-variable mirror 2 to an electrode 2a, an image-pickup unit 5 having an image-pickup element, such as a CCD (abbreviated from Charge Coupled Device) and an image sensor, for picking up images focused via the taking-lens system 1 and the shape-variable mirror 2, an image-signal processing unit 6 for processing an image signal from the image-pickup unit 5, a control unit 7 for controlling the entire system, an image-pickup button 8, an image storing unit 9 such as a memory for storing picked-up images, an image display and confirmation unit 10 for displaying images, a timer 11 for picking up images at a time after a predetermined period of time from image pick up operation, and a remote controller 12 for picking up operation from outside.

In addition, FIG. 1 shows an example in that object information within the image sensor is controlled by an electronic shutter function of the CCD image sensor. That is, directly before the pickup, a signal within the image sensor is cleared and a signal is transferred outside the image sensor immediately after the pickup.

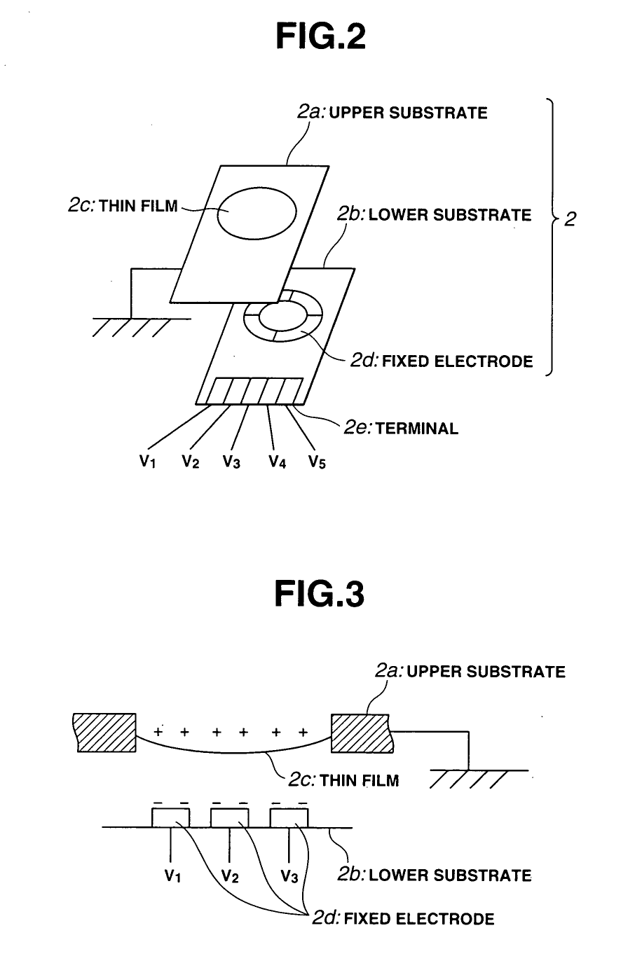

Next, the structure of the shape-variable mirror 2 will be described with reference to FIGS. 2 and 3. FIG. 2 is an exploded perspective view of a principle structure of the shape-variable mirror 2; and FIG. 3 is an explanatory view for illustrating the principle structure of the shape-variable mirror 2 by showing a cross-sectional shape of the shape-variable mirror 2.

This shape-variable mirror 2 is constructed to include an upper substrate 2a, a circular thin film 2c with the periphery held by the upper substrate 2a, a lower substrate 2b arranged to oppose the upper substrate 2a at a predetermined interval therebetween, a plurality of fixed electrodes 2d fixed and held to the lower substrate 2b so as to oppose the thin film 2c, and terminals 2e arranged on the lower substrate 2b so as to respectively connect the plurality of fixed electrodes 2d electrically thereto so as to apply a voltage supplied from the drive unit 4 to the fixed electrodes 2d.

The thin film 2c is an organic film with the upper surface shown in FIGS. 2 and 3 and coated with a conductive material, such as aluminum, so as to reflect incident light from the above viewed in FIGS. 2 and 3. Also, the aluminum or the like, applied to the organic film is grounded.

In the example shown in FIG. 2, the fixed electrode 2d is composed of five electrodes in total that are one central circular electrode and four-divided annular shaped sections disposed in the circumstance of the central electrode.

In accordance with the structure of the fixed electrode 2d, the terminal 2e has five terminals for applying respective voltages V1, V2, V3, V4, and V5 to the electrodes.

In addition, the space between the upper substrate 2a and the lower substrate 2b is maintained constant by inserting a spacer (although not shown) therebetween, for example.

The operation of such a shape-variable mirror 2 is as follows:

Upon making a potential difference between the thin film 2c and the fixed electrode 2d by applying the voltages V1, V2, V3, V4, and V5 to the fixed electrode 2d, Coulomb's force is produced between the fixed electrode 2d and the thin film 2c in directions attractive with each other. Because the fixed electrode 2d is fixed to the lower substrate 2b, only the thin film 2c is pulled toward the fixed electrode 2d.

Since the periphery of the thin film 2c is fixed on the upper substrate 2a, the thin film 2c is deformed so as to have a gradually concave surface so that the central portion of the thin film approaches the fixed electrode 2d at most. Thereby, the aluminum surface applied on the upper surface of the thin film 2c viewed in FIGS. 2 and 3 forms a concave reflection plane (mirror plane) so as to function as an optical plane with power.

In such a manner, the shape-variable mirror 2 that is an active optical element has a functional region formed so as to emit light by converting optical characteristics of incident light in accordance with an applied drive signal.

At this time, as described above, even when the thin film 2c is deformed, sound is scarcely produced by the deformation. Furthermore, the electric power required for the deformation and for maintaining the deflected state is extremely small.

In the structure in principle described above, by devising a manner for dividing the fixed electrode 2d and the shape of the divided section, and also by appropriately controlling a potential to be applied to each fixed electrode 2d, the shape (including a curvature) of the thin film 2c can be varied in a desired one. At this time, the mirror shape can be changed not only in a shape with a constant curvature, but also in an elliptical surface of revolution, a parabolic surface of revolution, or furthermore complicated free-form surface.

By such changes in curvature of the shape-variable mirror 2 having the same advantages as those in curvature of a lens in an optical system, a focusing function is to be achieved according to the embodiment as will be described in the following.

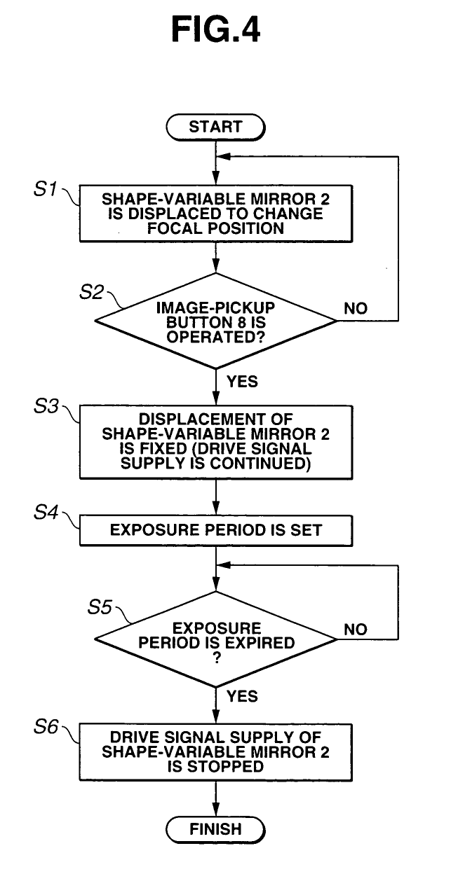

Next, the operation will be described with reference to the operation flowchart shown in FIG. 4.

The light passing through the taking-lens system 1 is to be reflected by the shape-variable mirror 2 so as to focus on the image-pickup unit 5. Upon obtaining an image signal from the focused object images via the image-pickup unit 5, the system control unit 7 displaces the reflection plane of the shape-variable mirror 2 by controlling the drive unit 4 so as to feed a drive signal to the shape-variable mirror 2 and to change a focal position for obtaining appropriate images (Step S1).

Then, the system control unit 7 determines whether the image-pickup button 8 is operated by a user or the timer 11 and the remote controller 12 are operated (Step S2). If operated (YES in Step S2), the system control unit 7 controls the drive unit 4 so as to feed a drive signal for maintaining the present displacement magnitude to the shape-variable mirror 2 after the image-pickup unit 5 becomes in an image picking-up condition capable of obtaining an image signal of the object, so that the displacement magnitude of the shape-variable mirror 2 is maintained (Step S3). Wherein, if the image-pickup button 8, etc., is not operated (NO in Step S2), the step is returned to Step S1. Next, the system control unit 7 establishes an exposure period while maintaining the displacement magnitude of the shape-variable mirror 2 so as to start exposure (Step S4), and then to determine if the exposure period expires (Step S5). If the exposure period expires (YES in Step S5), the system control unit 7 controls the image-signal processing unit 6 to process an image signal from the image-pickup unit 5, and then, to store it in the image storing unit 9.

On the other hand, after the exposure period expires, when the image-pickup unit 5 becomes a state that an object image-signal can be readout so as to finish the image picking-up state of the image-pickup unit 5, the system control unit 7 stops feeding the drive signal to the shape-variable mirror 2 from the drive unit 4 (Step S6) so as to cancel the displacement of the shape-variable mirror 2. In addition, “the state that an object image-signal can be readout” means a state that an electric charge finishes to be transferred into a perpendicular transmission route in a CCD image-pickup element of an interlace readout type, for example.

Also, when necessary, images may be displayed on the image display and confirmation unit 10 by user's operation.

Upon determining an exposure period, the exposure needs to be detected from the image signal obtained by the image-pickup unit (generally called automatic exposure (AE)) in advance, but the detection is not necessarily executed in a focused state. Therefore, if the AE is executed in the focused state, it is controlled that the drive signal is continuously fed.

By such a configuration, when the image-pickup unit is at least picking up images of one or part of the process of the subsequent stage, such as AE (Automatic Exposure) processing, AF (Automatic Focus) processing, or picked-up image processing desired by a user, the system control unit controls the drive unit to continuously feed the drive signal so as to consequently maintain the displacement magnitude of the shape-variable mirror. Therefore, since the displacement magnitude of the shape-variable mirror is maintained during picking up images, appropriate images can be obtained. Also, since the drive signal is stopped the feeding during a period other than image-pickup time, the electric consumption can be reduced by appropriately stopping the power supply.

According to the embodiment, during picking up images, appropriate images desired by a user can be obtained while additional electric power consumption can be avoided during a period other than image-pickup time.

### Second Embodiment

Next, an image-pickup apparatus according to a second embodiment of the present invention will be described. The basic structure of the second embodiment is the same as that of the first embodiment shown in FIG. 1.

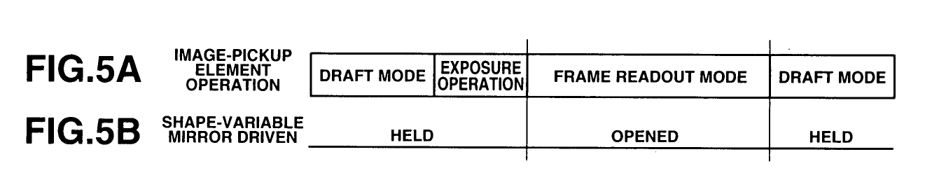

FIGS. 5A and 5B are timing charts illustrating the operation according to the embodiment. FIG. 5A shows the operation of an image-pickup element while FIG. 5B shows the driving state of the shape-variable mirror 2. Referring to FIG. 5A, a draft mode is a preparatory mode prior to the image pickup, and is used for reading out images from the image-pickup unit 6 in order to confirm images for picking up in the image display and confirmation unit 10 prior to the operation of the image-pickup button etc. The draft mode also denotes the readout operation mode for perpendicular-pixel skipping from the image-pickup element, and in addition to these, it may also denote the readout operation mode for horizontal-pixel adding depending on the kind of the image-pickup element. Also, a frame-readout mode is a readout mode after the image pickup by operating the image-pickup button or the like for reading out images from the image-pickup unit 6 in order to mainly record the images on the image storing unit 9. It denotes the operation mode for entire pixel reading out from the image-pickup element, for example.

According to the embodiment, as shown in FIGS. 5A and 5B, the image-pickup unit 5, such as a CCD image sensor, executes the exposure operation after the preceding draft mode, and in the period prior to the frame readout mode and until the exposure completion, the system control unit 7 controls the drive unit 4 to continuously feed the drive signal to shape-variable mirror 2 so as to maintain the displacement magnitude of the shape-variable mirror 2.

At the time setting in the state capable of reading out the image signal of an object after the exposure completion, the system control unit 7 stops feeding the drive signal to the shape-variable mirror 2 from the drive unit 4 so as to open the electrode 2a of the shape-variable mirror 2. Even if the drive signal is stopped, since the stored electric charge is remained in the electrode for a short period of time as long as both ends of the electrode are opened, the displacement magnitude of the shape-variable mirror 2 is maintained.

By such a configuration, since the displacement magnitude of the shape-variable mirror is maintained during exposure, optical system has been fixed until the exposure completion and appropriate images can be obtained. Also, since the drive signal is stopped after the exposure, the electric consumption can be reduced.

According to the embodiment, during exposure, appropriate images desired by a user can be obtained while, after exposure, the additional electric power can be avoided.

In addition, in each structure according to the embodiment, various modifications and amendments can be made. For example, the operation prior to the exposure may be incorporated in the frame readout mode different from the draft mode.

### Third Embodiment

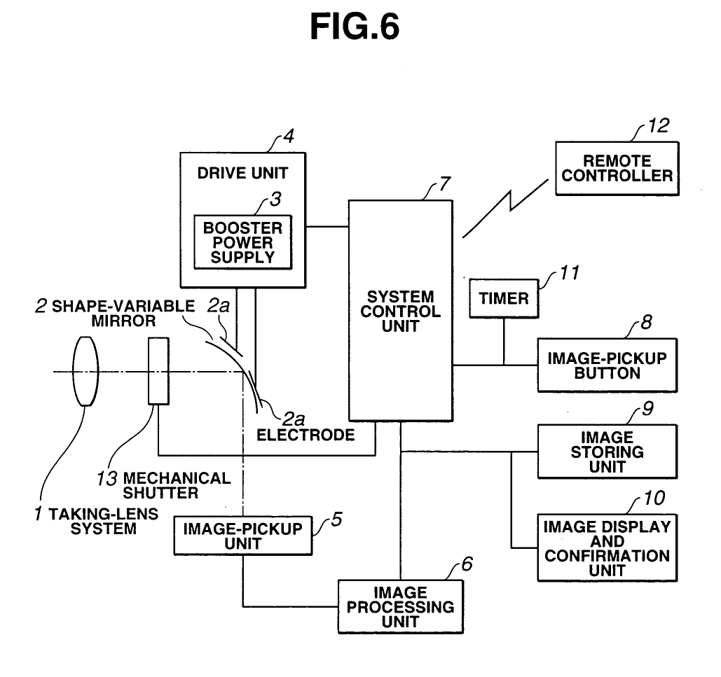

Next, an image-pickup apparatus according to a third embodiment of the present invention will be described. In the basic structure of the third embodiment, as shown in FIG. 6, a mechanical shutter 13 is arranged along an optical axis arranged toward the image-pickup unit 5 at the rear of the taking-lens system 1, and the basic structure of the third embodiment is the same as that of the first embodiment except that the mechanical shutter 13 is arranged.

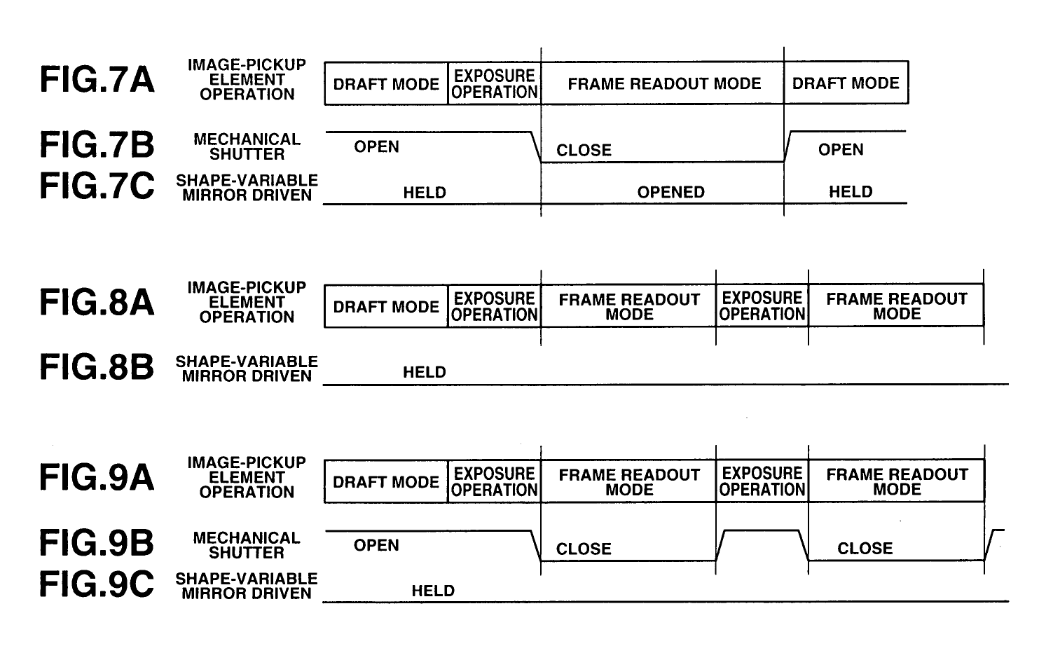

FIGS. 7A to 7C are timing charts illustrating the operation according to the embodiment. FIG. 7A shows the operation of the image-pickup element; FIG. 7B shows the driving state of the mechanical shutter 13; and FIG. 7C shows the driving state of the shape-variable mirror 2. The draft mode and the frame readout mode are the same as those described in FIG. 5A.

According to the embodiment, as shown in FIGS. 7B and 7C, while the mechanical shutter 13 is opened, when the image-pickup unit 5 is picking up images for use in at least one or part of a process of a subsequent stage, the system control unit 7 controls the drive unit 4 to continuously feed the drive signal to the shape-variable mirror 2 so as to maintain the displacement magnitude of the shape-variable mirror 2.

Then, after the mechanical shutter 13 is closed, the system control unit 7 stops feeding the drive signal to the shape-variable mirror 2 from the drive unit 4 so as to open the electrode 2a of the shape-variable mirror 2.

By such a configuration, since the displacement magnitude of the shape-variable mirror is maintained while the mechanical shutter 13 is opened, appropriate images can be obtained. Also, since the drive signal feeding is stopped after the mechanical shutter 13 is closed, the electric consumption can be reduced.

According to the embodiment, while the mechanical shutter 13 is opened, appropriate images desired by a user can be obtained and the additional electric power can be avoided after the mechanical shutter 13 is closed.

### Fourth Embodiment

Next, an image-pickup apparatus according to a fourth embodiment of the present invention will be described. The basic structure of the fourth embodiment is the same as that of the embodiments shown in FIG. 1 or FIG. 6.

FIGS. 8A and 8B are timing charts illustrating the operation without the mechanical shutter according to the embodiment (corresponding to FIG. 1). FIG. 8A shows the operation of an image-pickup element while FIG. 8B shows the driving state of the shape-variable mirror 2.

FIGS. 9A to 9C are timing charts illustrating the operation with the mechanical shutter according to the embodiment (corresponding to FIG. 6). FIG. 9A shows the operation of the image-pickup element; FIG. 9B shows the driving state of the mechanical shutter 13; and FIG. 9C shows the driving state of the shape-variable mirror 2.

According to the embodiment, as shown in FIGS. 8A and 8B, even after the time shifted to the frame readout mode from the draft mode via the exposure operation, the system control unit 7 controls the drive unit 4 to continuously feed the drive signal so as to maintain the displacement magnitude of the shape-variable mirror 2.

According to the embodiment, as shown in FIGS. 9B and 9C, even after the time shifted to the state that the mechanical shutter 13 is closed from the state that the mechanical shutter 13 is opened, the system control unit 7 controls the drive unit 4 to continuously feed the drive signal to the shape-variable mirror 2 so as to maintain the displacement magnitude of the shape-variable mirror 2.

By such a configuration, since the displacement magnitude of the shape-variable mirror is maintained even after the image-pickup unit 5 is shifted to the frame readout mode, appropriate images can be obtained. Also, since the displacement magnitude of the shape-variable mirror 2 is maintained while the image-pickup unit 5 is continuously picking up images of a plurality of frames, appropriate images can be obtained.

According to the embodiment, during continuously picking up, appropriate picked-up images desired by a user can be obtained.

### Fifth Embodiment

Next, a fifth embodiment of the present invention will be described. The basic structure of the fifth embodiment is the same as that of the embodiments shown in FIG. 1 or FIG. 6. In addition, in the case where the mechanical shutter 13 is provided as shown in FIG. 6, the mechanical shutter 13 is put into the opened state thereof during picking up motion images.

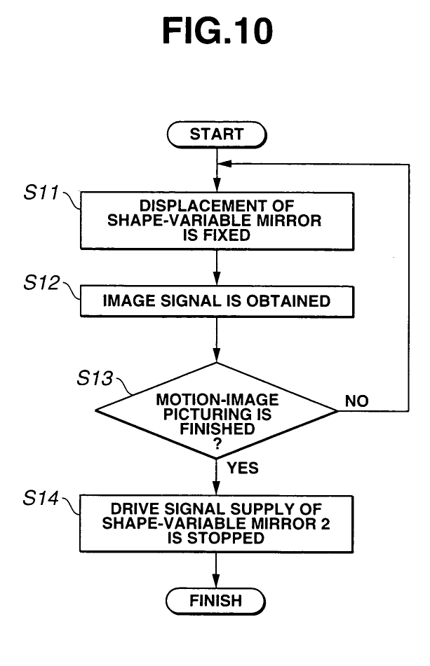

According to the embodiment, as shown in the operation flowchart of FIG. 10, if motion images are picked up, i.e., image picking-up is repeated, the system control unit 7 controls the drive unit 4 to continuously feed the drive signal to the shape-variable mirror 2 so as to fix the displacement magnitude of the shape-variable mirror 2 (Step S11), and after the image signal is obtained (Step S12), it determines whether motion images are being photographed (Step S13). If so, the displacement magnitude of the shape-variable mirror 2 is fixed as it is (Step S11), and if the motion images are finished photographing (YES in Step S13), the drive signal is stopped feeding to the shape-variable mirror 2 (Step S14).

Therefore, since the displacement magnitude of the shape-variable mirror is maintained while the image-pickup unit 5 photographs motion images, appropriate images can be obtained.

According to the embodiment, during the photographing motion images, appropriate picked-up motion images desired by a user can be obtained.

In addition, in each structure according to the embodiment of the present invention, various modifications and amendments can be obviously made. For example, the optical system by the shape-variable mirror 2 can be incorporated not only into the digital camera but also into an optical system such as a silver film camera, and as for the image pickup element, an MOS image-pickup element may also be applied in addition to the CCD.

The shape-variable mirror itself is basically returned to a shape without displacement in nature, whereas according to the embodiments described above, during picking up images, by maintaining the displacement state of the shape-variable mirror, required images can be obtained while in a period other than the image-pickup, additional electric power consumption can be avoided by stopping the drive of the shape-variable mirror.

### Sixth Embodiment

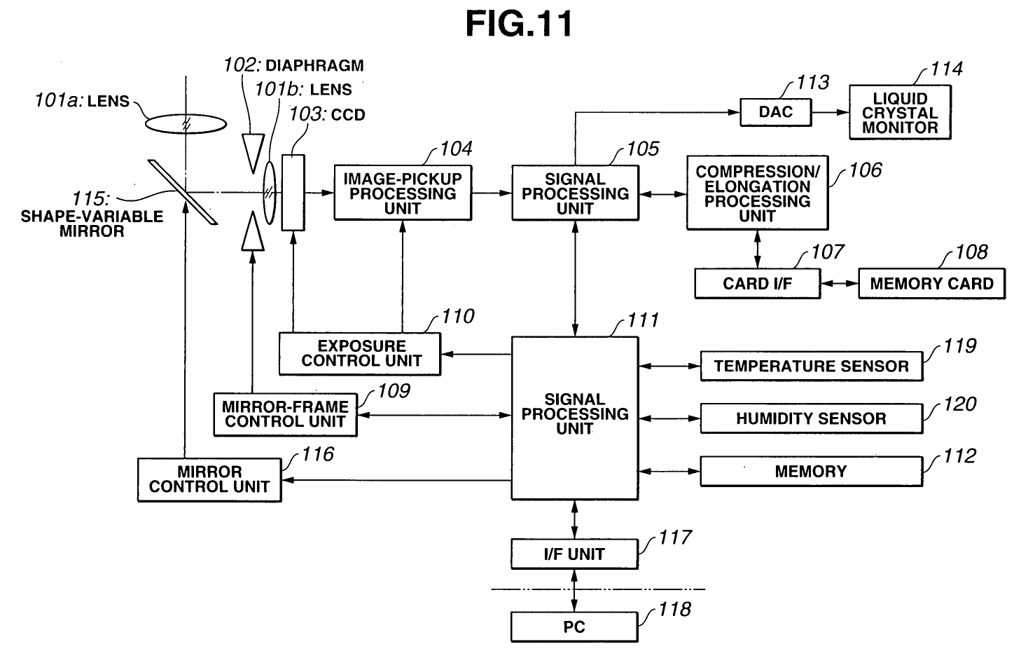

FIGS. 11 to 14 show a sixth embodiment of the present invention: FIG. 11 is a block diagram of a digital camera.

An image-pickup apparatus according to the sixth embodiment is a digital camera, for example, and it is constructed to include the following elements.

An image-pickup optical system (optical system) includes a lens 101a, a shape-variable mirror 115 that is an active optical element capable of deforming a mirror plane by applying a voltage for reflecting a luminous flux passing through the lens 101a, and a lens 101b for focusing a luminous flux reflected by the shape-variable mirror 115 on a surface of a CCD 103, which will be described later, so as to form object images. In addition, the shape-variable mirror 115 is the same in construction as the shape-variable mirror 2 shown in FIGS. 2 and 3 described in the first embodiment.

In addition, the above-mentioned lenses 101a and 101b schematically represent an optical system except the shape-variable mirror 115 in an image-pickup optical system for focusing an object image on an image area of the CCD 103, and it is a more complicated optical system in practice having a number of lenses.

A diaphragm 102 is arranged between the shape-variable mirror 115 and the lens 101b on an optical path of the image-pickup optical system for controlling the amount of light of optical images focused on the CCD 103 by restricting a passage range of incident light if necessary.

The CCD 103 is an image-pickup element for photo-electrically converting an optical object image focused by the operation of the image-pickup optical system into an electrical picked-up image so as to be produced as an image-pickup signal.

An image-pickup processing unit 104 includes a CDS (Correlated Double Sampling) circuit, an AGC (Automatic Gain Control) circuit, and an ADC (Analog to Digital Converter) for removing reset noise, which may be included in picked-up images produced from the CCD 103, and also for converting processed picked-up images, which are analogue signals, into digital picked-up image data by adjusting a signal level.

A signal-processing unit 105 is for processing correction, such as white balance and γ correction, on elongated picked-up image data produced by a compression/elongation processing unit 106, which will be described later. The signal-processing unit 105 further includes preparatory circuits for photographing, such as an AE (Automatic Exposure) detector circuit for determining exposure prior to photographing and an AF (Automatic Focus) detector circuit for obtaining a contrast assessment value for auto-focus control.

The compression/elongation processing unit 106 is for compressing picked-up image data produced by the signal-processing unit 105 and also for elongating compressed image data produced by a card I/F unit 107, which will be described. At this time, the compression/elongation processing is performed by a JPEG (Joint Photographic Experts Group) system, for example.

The card I/F unit 107 is an interface for giving and receiving various data, including writing and reading out picked-up image data, between the digital camera and a memory card 108, which will be described later.

The memory card 108 is for recording and holding various data including picked-up image data as a recording medium using a semiconductor, for example. The memory card 108 is constructed detachably with the digital camera, for example. Therefore, the memory card 108 is not a structural requirement inherent to the digital camera.

A mirror-frame control unit 109 is for zooming by controlling the lenses 101a and 101b corresponding to a command from a CPU (Central Processing Unit) 11, which will be described later as a control unit, and for adjusting exposure by controlling the diaphragm 102. In addition, the mirror-frame control unit 109 controls only the diaphragm 102 if the optical system is not a zoom lens or it is a manual zoom.

An image-pickup control circuit 110 is for controlling image picking-up operation by the CCD 103 and the image-pickup processing unit 104 according to a command from the CPU 111.

The CPU 111 is a control unit for controlling the operation of the entire digital camera as a central processing unit.

The memory 112 is a semiconductor memory including an ROM (Read Only Memory) having a control program stored in advance for allowing the CPU 111 to control the operation of the entire digital camera and an RAM (Random Access Memory) used as an operation memory region used when the CPU 111 executes the control program.

A DAC (Digital to Analog Converter) 113 is for converting picked-up image data produced by the signal-processing unit 105 as a digital signal into an analogue signal.

A liquid crystal monitor 114 is a display for observably displaying analogue picked-up images produced by the DAC 113.

A mirror control unit 116 is an active optical-element drive-unit for deforming the shape-variable mirror 115 in a desired shape by changing a voltage (drive signal) applied to the shape-variable mirror 115 according to a command from the CPU 111.

An I/F (Interface) 117 is for the control when data is given and received between the CPU 111 of the digital camera and a PC (Personal Computer) 118, which will be described, having an interface circuit for a USB (Universal Serial Bus), for example.

The PC 118 is for storing various data to be recorded in advance in the digital camera in a manufacturing process of the digital camera. For example, it is used for writing data for correcting sensitiveness of the CCD 103 on the memory 112 and for writing data for controlling the shape-variable mirror 115 on a look-up table, which will be described later, of the mirror control unit 116. Therefore, the PC 118 is not a component constituting the digital camera.

A temperature sensor 119 is a temperature detection unit for detecting the temperature in the environment having the digital camera placed therein so as to produce it to the CPU 111.

A humidity sensor 120 is a humidity detection unit for detecting the humidity in the environment having the digital camera placed therein based on the control of the CPU 111 so as to produce it to the CPU 111.

In a general digital camera, the shape-variable mirror 115 has a diameter of about 8 mm and a maximum deformation amount at the center produced by an applied voltage is about 20 μm, and these values are limits to the applied voltage and optical aberration.

Accordingly, in order to enable a focal point to be adjusted with such a displacement magnitude, the magnification of the optical system located nearer to the CCD 103 than the shape-variable mirror 115 (i.e., the lens 101b in the optical system schematically shown in FIG. 11) is increased.

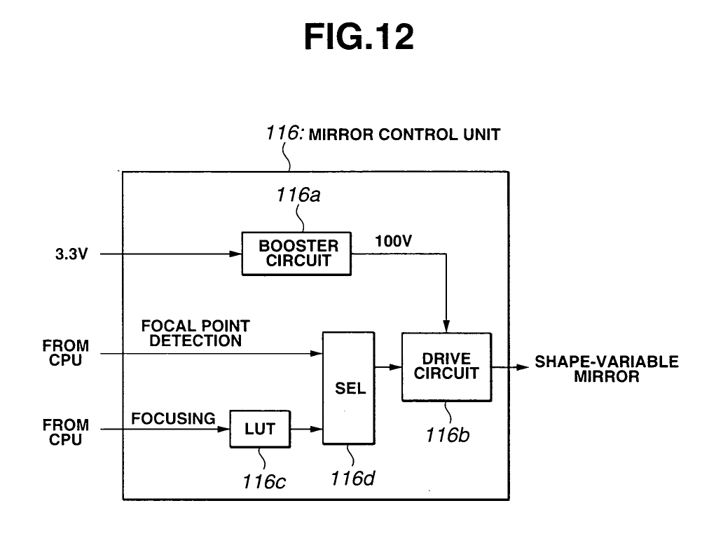

FIG. 12 is a block diagram of a structural example of the mirror control unit 116.

The mirror control unit 116 includes a booster circuit 116a for raising a voltage of 3.3 v from a power supply (not shown) inside the digital camera to a voltage of 100 v, for example, to be needed to drive the shape-variable mirror 115; an LUT (look up table) 116c for storing information for controlling the shape-variable mirror 115 as a table so as to produce stored information when focusing according to a command fed from the CPU 111; a signal selector (“S E L” in the drawing) 116d for selecting the control signal of the shape-variable mirror 115 fed from the CPU 111 so as to be produced to a drive circuit 116b, which will be described later, when detecting a focal point by the control of the CPU 111 and also for selecting the output signal of the LUT 116c so as to be produced to the drive circuit 116b when focusing; and the drive circuit 116b for producing the voltage for applying to each of the fixed electrodes 115d corresponding to the output from the signal selector 116d from the voltage received from the booster circuit 116a.

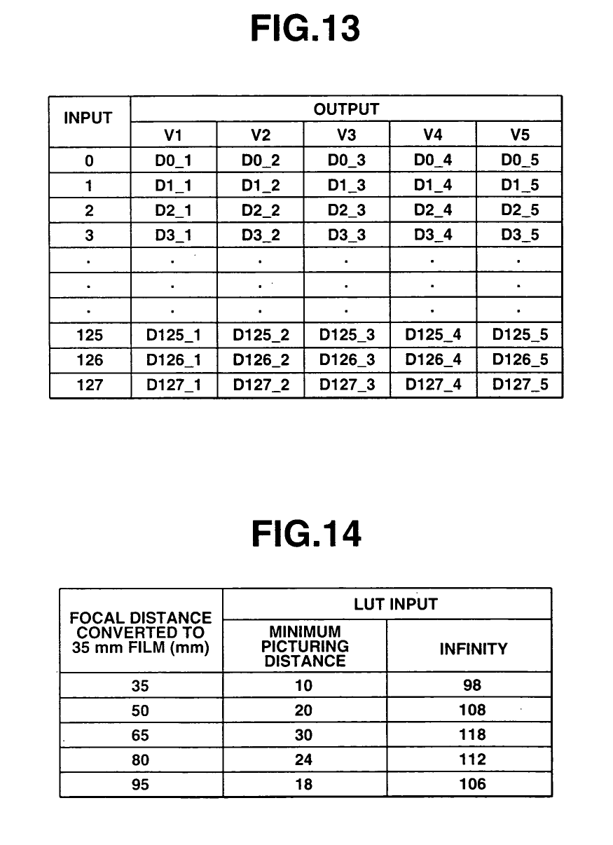

In the mirror control unit 116 structured as above, if voltages applied to terminals 115e (not shown) equivalent to the terminals 2e of the shape-variable mirror 2 are V1, V2, . . . V5 in the same way as in FIG. 2, the focal point detection is operated by inputting the voltages V1, V2, . . . V5, which will be applied to each of the terminals 115e, into the signal selector 116d to be selected by a command from the CPU 111. On the other hand, the focusing is operated such that when an in-focus-plane position is required by the focal point detection, the information corresponding to the in-focus-plane position is produced from the CPU 111 to the LUT 116c so that the table as shown in FIG. 13 is referenced in the LUT 116c so as to input it to the signal selector 116d to be selected.

FIG. 13 is a table of a data example stored in the LUT 116c.

The voltages V1, V2, . . . V5 (output information produced to the drive circuit 116b in more detail), which are applied to each of the terminals 115e, are established at 128 stages corresponding to 0 to 127 input information in the example of FIG. 13. The reason why the resolution of the input information is set comparatively high, such as 128 stages, is for controlling the in-focus-plane position at an interval of the depth of field or less.

In the digital camera structured as above, if a distance is measured before measuring light, the precise distance may not measured depending on the object brightness as described above. Therefore, according to the embodiment, the photographing operation of the digital camera is performed as follows.

First, a light-measuring area is set on a photographing screen and then, the exposure is adjusted by detecting a photographing signal within the light-measuring area so as to change a shutter speed, an aperture scale, and a photographing signal level.

After completion of measuring light, a focus area is set on the photographing screen and then, the focal-point position is controlled by detecting a suitable-exposure photographing signal within the focus area with the contrast detection system so as to drive the shape-variable mirror 115.

When the distance is measured after the measuring light in such a manner, in the digital camera using the shape-variable mirror 115 as in the embodiment, the accuracy in the height of the shape-variable mirror 115 must be high, and this will be described.

In a general digital camera in that the focus is adjusted by adjusting a lens position, if summing up errors in size of optical components such as a mirror frame and mounting errors, the focus adjustment system may have errors of several tens to one hundred and several tens micron meter in total. It is difficult to reduce the errors by further improving the accuracies in the manufacturing process. If it would be done so, tremendous cost and labor-hour might be added. Therefore, in practical digital cameras, generally, the focus adjustment range may have a margin while the number of drive pulses may be adjusted when a focus lens group is driven with a stepping motor.

In more detail, in an optical system for general digital cameras, the lens displacement required for the focal adjustment is about several millimeters and on both respective ends of the displacement range, a margin of several tens micron meters is given. Even when a focus lens group is abutted at one end of the displacement range including the margins, since the errors are several tens micron meters relative to the focal adjustment range of several millimeters, the system cannot be extremely defocused. Therefore, when the AE operation and AWB (auto white balance) operation are performed prior to photographing, if the focusing state is not conscious, i.e., the lens is not driven toward the focus position, the exposure adjustment and the white balance adjustment may be generally and preferably performed within a short period of time.

Whereas in the digital camera using the shape-variable mirror 115 for adjusting the focal point, it is possible that if the adjustment might be done in the same manner, there may be produced large defocus as will be described in the following.

That is, in the optical system of the digital camera in that the shape-variable mirror 115 is incorporated in the focal adjustment, since the focus sensitivity is increased with increasing deformation amount of the shape-variable mirror 115 as described above, the sensitivity to the size and the mounting position of the shape-variable mirror 115 is also increased, so that the focal point position is largely displaced even with the small error. Therefore, in the state that the shape-variable mirror 115 is deformed, if the system is focused in the range from a minimum photographing distance to infinity while the errors are absorbed, the system is put into an extremely defocused state in a state that the shape-variable mirror 115 is not deformed. In this extremely defocused state, even if light is measured, the precise exposure adjustment is difficult as described above.

Then, in the digital camera according to the embodiment, the shape-variable mirror 115 is deformed so as to enable the exposure adjustment to be preferably performed, then light measuring and the white balance are executed, and then the auto focus is further performed. That is, further prior to the measuring light preceding measuring the length, the shape-variable mirror 115 is deformed so as to have an appropriate focal position.

In addition, if the optical system incorporates a varifocal lens, which is a variable-focal optical system, the focal point is displaced with changes in the focal length. However, this displacement can be absorbed by the deformation of the shape-variable mirror 115. That is, it is set that the displacement magnitude of the shape-variable mirror 115 is added on the variation of the focal length, so that the system can be focused in the entire range from a near point to infinity.

For example, the digital camera incorporates the optical system using the varifocal lens, which is a variable-focal optical system, capable of changing the focal length in steps, so that the focal length converted to a 35 mm film can be changed to 35 mm, 50 mm, 65 mm, 80 mm, and 95 mm.

The inputs to the LUT 116c in these converted focal length are shown in FIG. 14, for example. FIG. 14 is a table showing changes in the input of the LUT 116c with the focal length.

That is, in the case where the focal length converted to the 35 mm film is equivalent to 35 mm, the input to the LUT 116c for focusing at a minimum length is 10 and the input to the LUT 116c for focusing at infinity is 98; if the focal length is equivalent to 50 mm, the input to the LUT 116c for focusing at a minimum length is 20 and the input to the LUT 116c for focusing at infinity is 108; if the focal length is equivalent to 65 mm, the input to the LUT 116c for focusing at a minimum length is 30 and the input to the LUT 116c for focusing at infinity is 118; if the focal length is equivalent to 80 mm, the input to the LUT 116c for focusing at a minimum length is 24 and the input to the LUT 116c for focusing at infinity is 112; and if the focal length is equivalent to 95 mm, the input to the LUT 116c for focusing at a minimum length is 18 and the input to the LUT 116c for focusing at infinity is 106.

In such a manner, without errors in consideration, the inputs to the LUT 116c for focusing at the entire focal length are to be 10 to 118 so that the system can be focused in the range from a minimum distance to infinity. In addition to this, a margin is assumed from the correction of errors in size of components, mounting errors, and the AF allowance for detecting peaks of the contrast by the mountain climbing system so as to have 9 corresponding to the input value. That is, among the prepared input values of 0 to 127, values of 1 (i.e., 10−9) to 127 (i.e., 118+9) are used for control as the input value.

Thus, the operation of practical photographing with such a digital camera is as follows.

Upon turning on the power supply to the digital camera, the power supply voltage supplied from a battery is confirmed whether it is within a predetermined range by the output of a sensor (not shown) and further if the memory card 108 capable of recording is provided.

Next, in order to avoid the extreme defocus described above, among control tables stored in the LUT 116c of the mirror control unit 116, a central value (focal position located substantially at the center) of 64 in the values of 1 to 127, which are added by the error correction and the AF allowance, is used for the input to the LUT 116c so as to drive the shape-variable mirror 115, so that in the state that the shape thereof is maintained, the AF operation for determining the exposure amount and the AWB operation for adjusting the white balance are controlled.

Wherein for the entire focal length adaptable to the variable focal-point optical system, the central value (first central value) of 64 is used in focusing range values of 1 to 127 including errors; alternatively, an input value of 64 may be used, which (occasionally the same as the first central value but generally different) is located in the substantial intermediate of focusing-range input values 30 to 98 commonly included in the entire focal lengths adaptable to the variable focal-point optical system. Since these values are within the focus range at the entire focal length (including error correction), the system is not put into an extremely defocused state as in a state in which the shape-variable mirror 115 is not driven, and this enables the precise exposure control.

In the optical system incorporating the varifocal lens, if more suitable exposure control is required, the value in the vicinity of the central value (focal position located substantially at the center) may also be used in the range of input values corresponding to the focal length. Specifically, if the focal length converted to the 35 mm film is equivalent to 35 mm, the input to the LUT 116c may be appropriately 54, which is the center of 10 to 98; and if the focal length is equivalent to 50 mm, the input to the LUT 116c may be appropriately 64, which is the center of 20 to 108.

Furthermore, a thin film 115c made of an organic film coated with aluminum may change in shape by environmental factors such as temperature and humidity. Thus, using the temperature information produced from the temperature sensor 119 and the humidity information produced from the humidity sensor 120, more precise AF control, AE control, and AWB control can also be performed by suitably changing the control table and correcting the input value of the control table.

At this time, the detection is not limited to the temperature and the humidity as mentioned above, and factors affecting the driving state of the active optical element may be detected more widely. Thereby, more precise light measuring and distance measuring may be enabled. For example, it is enumerated as another example that a gravity direction is detected and the voltage to be applied is controlled corresponding to the gravity direction.

In order to maintain the shape of the shape-variable mirror 115, it is a simplest way to hold the applied voltage. If the shape-variable mirror 115 is a type in that the shape of the reflection plane is controlled by Coulomb's force as described above, the shape can be held even if the voltage is stopped applying as long as it is within a short time. Therefore, within a predetermined period of time, AE operation and AWB operation can be executed in the stopped state of the shape-variable mirror 115.

In the above description, the shape-variable mirror 115 is exemplified as an active optical element; and the invention is not limited to this so that another active optical element may be used.

Moreover, in the above description, the mirror control unit 116 produces a drive signal corresponding to a substantially intermediate focusing position within a focusing range from a minimum photographing distance to infinity; alternatively, even when it produces a drive signal corresponding to any focusing position within a focusing range from a minimum photographing distance to infinity, advantages may be produced to some extent.

According to the embodiments described above, since after the shape-variable mirror is driven at an appropriate position, the exposure is suitably controlled with the AE operation, the AE operation in an extremely defocused state can be avoided, obtaining suitable exposure.

Then, after the AE operation, the AF operation is executed using images picked up in an appropriate exposure state, so that an object can be precisely focused by correctly detecting a focal point not depending on the brightness of the object.

According to the embodiment, in the case of the optical system using the variable focal-point optical system, the system is driven at a substantially intermediate focusing position within the focusing range commonly included in entire focal lengths adaptable to the variable-focal point optical system, so that photographing preparatory operations, such as the AE and the AWB, can be constantly executed in a stable state regardless of the focal length state.

Whereas in the case where the system is driven at an arbitrary focusing position within a focusing range, photographing preparatory operations can be substantially suitably executed within a shorter period of time.

Furthermore, temperature and humidity are detected so as to drive the shape-variable mirror corresponding to the detected result, so that photographing preparatory operations can be stably executed without being affected by environmental factors, enabling the focal length to be detected.

The present invention is not limited to the embodiments described above, so that various modifications and alternatives can be obviously made within the spirit and the scope of the invention.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image-pickup apparatus comprising:
a shape-variable mirror having a deformable reflection plane and an electrode for controlling the shape of the reflection plane;
a drive unit for feeding a signal for driving the reflection plane to the electrode;
a taking-lens system for defining a focal length in accordance with the deformation amount of the reflection plane of the shape-variable mirror;
an image-pickup unit for picking up images focused via the taking-lens system and the shape-variable mirror; and
a control unit for controlling the drive unit so as to continuously feed the drive signal -in order to maintain the deformation state of the shape-variable mirror when the image-pickup unit is picking up images for use in one or part of a process of a subsequent stage.

2. An image-pickup apparatus according to claim 1, wherein the control unit stops feeding the drive signal from the drive unit at a time other than when the image-pickup unit is picking up the subsequent-stage processing images.

3. An image-pickup apparatus according to claim 1, wherein the control unit continues to feed the drive signal from the drive unit during exposure.

4. An image-pickup apparatus according to claim 3, wherein the control unit stops feeding the drive signal from the drive unit after the exposure.

5. An image-pickup apparatus according to claim 1, wherein the control unit continues to feed the drive signal from the drive unit during changing the number of pixels read from the image-pickup unit.

6. An image-pickup apparatus according to claim 5, wherein the control unit stops feeding the drive signal from the drive unit after the number of pixels read from the image-pickup unit is changed.

7. An image-pickup apparatus according to claim 1, further comprising a mechanical shutter, wherein when the mechanical shutter is opened, the control unit continues to feed the drive signal from the drive unit when the image-pickup unit is picking up images of at least one or part of the process of the subsequent stage.

8. An image-pickup apparatus according to claim 7, wherein the control unit stops feeding the drive signal from the driving unit after the mechanical shutter is closed.

9. An image-pickup apparatus according to claim 1, wherein the control unit continues to feed the drive signal from the drive unit even after the image-pickup unit is shifted to a frame-readout mode.

10. An image-pickup apparatus according to claim 9, wherein the control unit continues to feed the drive signal from the drive unit while the image-pickup unit is continuously picking up images.

11. An image-pickup apparatus according to claim 9, wherein the control unit continues to feed the drive signal from the drive unit while the image-pickup unit is picking up motion images.

12. An image-pickup apparatus comprising:
an optical system comprising an active optical element having a functional region that converts optical characteristics of incident light in accordance with an applied drive signal so as to emit it;
an image-pickup element that photo-electrically converts object images focused via the optical system;
a signal processing unit for processing an image-pickup signal of the object images produced from the image-pickup element in a predetermined manner;
an active optical-element drive unit for producing a drive signal to be applied to the active optical element; and
a control unit for controlling the active optical-element drive unit,
wherein prior to picking up images, the control unit controls the active optical-element drive unit so as to apply a predetermined drive signal to the active optical element so that a focal position of the optical system is accordingly adjusted.

13. An image-pickup apparatus according to claim 12, wherein the active optical element is a shape-variable mirror with optical characteristics changeable by varying the shape of a reflection plane.

14. An image-pickup apparatus according to claim 12, wherein upon determining an exposure amount prior to picking up images, the control unit controls the active optical-element drive unit so as to apply a predetermined drive signal to the active optical element.

15. An image-pickup apparatus according to claim 12, wherein upon adjusting a white balance prior to picking up images, the control unit controls the active optical-element drive unit so as to apply a predetermined drive signal to the active optical element.

16. An image-pickup apparatus according to claim 12, wherein the active optical-element drive unit produces a drive signal corresponding to any focusing position within a focusing range from a minimum imaging distance to infinity as a predetermined drive signal in that a focal position of the optical system is accordingly adjusted.

17. An image-pickup apparatus according to claim 14, wherein the active optical-element drive unit produces a drive signal corresponding to any focusing position within a focusing range from a minimum imaging distance to infinity as a predetermined drive signal in that a focal position of the optical system is accordingly adjusted.

18. An image-pickup apparatus according to claim 16, wherein the active optical-element drive unit produces a drive signal corresponding to a substantially intermediate focusing position within the focusing range as a predetermined drive signal in that a focal position of the optical system is accordingly adjusted.

19. An image-pickup apparatus according to claim 12, wherein the optical system comprises a variable-focal point optical system, and wherein the active optical-element drive unit produces a drive signal corresponding to any focusing position in entire focal lengths adaptable to the variable-focal point optical system within a focusing range from a minimum photographing distance to infinity as a predetermined drive signal in that a focal position of the optical system is accordingly adjusted.

20. An image-pickup apparatus according to claim 14, wherein the optical system comprises a variable-focal point optical system, and wherein the active optical-element drive unit produces a drive signal corresponding to any focusing position in entire focal lengths adaptable to the variable-focal point optical system within a focusing range from a minimum photographing distance to infinity as a predetermined drive signal in that a focal position of the optical system is accordingly adjusted.

21. An image-pickup apparatus according to claim 19, wherein the active optical-element drive unit produces a drive signal corresponding to a substantially intermediate focusing position within the focusing range commonly included in entire focal lengths adaptable to the variable-focal point optical system as a predetermined drive signal in that a focal position of the optical system is accordingly adjusted.

22. An image-pickup apparatus according to claim 12, further comprising a temperature-detection unit, wherein the active optical-element drive unit corrects a drive signal in accordance with a detected signal from the temperature-detection unit.

23. An image-pickup apparatus according to claim 12, further comprising a humidity-detection unit, wherein the active optical-element drive unit corrects a drive signal in accordance with a detected signal from the humidity-detection unit.
